(19) United States
(12) Patent Application Publication
(10) Pub. No.: US 2026/0106259 A1
(43) Pub. Date: Apr. 16, 2026

(54) BATTERY USING MULTI FIN STRUCTURE, METHOD OF MANUFACTURING THE BATTERY, AND COOLING CHANNEL

(71) Applicant: SAMSUNG SDI CO., LTD., Yongin-si (KR)

(72) Inventor: Youngsun CHA, Yongin-si (KR)

(21) Appl. No.: 19/266,567

(22) Filed: Jul. 11, 2025

(30) Foreign Application Priority Data
Oct. 15, 2024 (KR) 10-2024-0140747

(51) Int. Cl. H01M 10/653; H01M 10/613; H01M 10/647; H01M 10/6551; H01M 10/656

(52) U.S. Cl. CPC H01M 10/653; H01M 10/613; H01M 10/647; H01M 10/6551; H01M 10/656

(57) ABSTRACT

A battery using a multi fin structure, the battery including a plurality of cells configured to perform a charge and discharge function, and a cooling channel under the plurality of cells to adjust a temperature of each of the plurality of cells, wherein the cooling channel includes a fin having a multi-structure.

### CROSS-REFERENCE TO RELATED APPLICATIONS

This application claims the benefit of the Korean Patent Application No. 10-2024-0140747 filed on Oct. 15, 2024, which is hereby incorporated by reference as if fully set forth herein.

### BACKGROUND

### 1. Field

Embodiments relate to a battery using a multi fin structure, a method of manufacturing the battery, and a cooling channel, and more particularly, to a battery using a multi fin structure, a method of manufacturing the battery, and a cooling channel, which may help delay thermal runaway in a battery using a multi fin structure.

### 2. Description of the Related Art

Unlike primary batteries that are not designed to be charged, secondary batteries are designed to be discharged and recharged. Low-capacity secondary batteries may be used in small portable electronic devices, e.g., smart phones, feature phones, notebook computers, digital cameras, and camcorders, while large-capacity secondary batteries may be widely used as power sources for driving motors, e.g., of hybrid vehicles or electric vehicles, and for power storage. The secondary battery may include, e.g., an electrode assembly consisting of a positive electrode and a negative electrode, a case that accommodates the electrode assembly, a terminal part connected to the electrode assembly, or the like.

The above information disclosed in this Background section is for enhancement of understanding of the background of the present disclosure, and therefore, it may contain information that does not constitute related (or prior) art.

### SUMMARY

Embodiments are directed to a battery using a multi fin structure, the battery including a plurality of cells configured to perform a charge and discharge function, and a cooling channel under the plurality of cells to adjust a temperature of each of the plurality of cells, wherein the cooling channel includes a fin having a multi-structure.

The fin may include a layer in an inner portion including hardened octadecane and silver nano particles.

The fin may include a layer in an inner portion including hardened octadecane and copper nano particles.

The fin may include a first layer in an inner portion including a first phase change material, and a second layer in an inner portion including a second phase change material.

The first layer may include hardened octadecane coated on an inner portion of the fin.

The second layer may be in an internal space of the first layer and may include a hardened mixture of octadecane, silver nano particles, and multi-walled carbon nanotube (MWCNT).

The second layer may be in an internal space of the first layer and may include a hardened mixture of octadecane, copper nano particles, and multi-walled carbon nanotube (MWCNT).

Embodiments are directed to a method of manufacturing a battery using a multi fin structure, the method including a step of providing a plurality of cells configured to perform a charge and discharge function, and a step of placing a cooling channel, configured to adjust a temperature of each of the cells, under the plurality of cells, wherein the step of placing the cooling channel includes a step of manufacturing the cooling channel which is configured in a multi-structure and includes a fin.

The step of manufacturing the cooling channel may include a step of manufacturing a fin including a layer which may be formed by inserting and hardening octadecane and silver nano particles into the fin.

The step of manufacturing the cooling channel may include a step of manufacturing a fin including a layer which may be formed by inserting and hardening octadecane and copper nano particles into the fin.

The step of manufacturing the cooling channel may include a step of forming a first layer, including a first phase change material, in the fin, and a step of forming a second layer, including a second phase change material, in the fin.

The step of forming the first layer may include a step of coating and hardening octadecane of a liquid state on an inner portion of the fin to form the first layer.

The step of forming the second layer may include a step of mixing octadecane, silver nano particles, and multi-walled carbon nanotube (MWCNT) and inserting and hardening the mixed materials into an internal empty space of the first layer to form the second layer.

The step of forming the second layer may include a step of mixing octadecane, copper nano particles, and multi-walled carbon nanotube (MWCNT) and inserting and hardening the mixed materials into an internal empty space of the first layer to form the second layer.

Embodiments are directed to a cooling channel using a multi fin structure, the cooling channel including a fin part including a plurality of fins, a lower plate part under the fin part to fix the fin part, and a side bar connected to the lower plate part to support both sides of the fin part, wherein at least one fin of the plurality of fins has a multi-structure.

The at least one fin may include a layer in an inner portion including hardened octadecane and silver nano particles.

The at least one fin may include a layer in an inner portion including hardened octadecane and copper nano particles.

The at least one fin may include a first layer in an inner portion including a first phase change material and a second layer in an inner portion including a second phase change material.

The first layer may include hardened octadecane coated on an inner portion of the at least one fin.

The second layer may be in an internal space of the first layer and may include a hardened mixture of octadecane, silver nano particles, and multi-walled carbon nanotube (MWCNT).

### BRIEF DESCRIPTION OF THE DRAWINGS

Features will become apparent to those of skill in the art by describing in detail exemplary embodiments with reference to the attached drawings in which:

FIG. 1 is a schematic diagram illustrating a cylindrical lithium secondary battery according to embodiments.

FIG. 2 is a schematic diagram illustrating an angular lithium secondary battery according to embodiments.

FIGS. 3 and 4 are schematic diagrams illustrating a pouch-type lithium secondary battery according to embodiments.

FIG. 5 is a diagram illustrating a cell and a cooling channel according to embodiments of the present disclosure.

FIG. 6 is a cross-sectional view illustrating a cross-sectional surface of a fin according to a first embodiment of the present disclosure.

FIG. 7 is a cross-sectional view illustrating a cross-sectional surface of a fin according to a second embodiment of the present disclosure.

FIG. 8 is a diagram illustrating a cooling channel according to embodiments of the present disclosure.

FIG. 9 is a flowchart for describing a method of manufacturing a battery according to embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals are designated to the same components in different embodiments.

Reference to two compared elements, features, etc. as being “the same” means that they are “substantially the same”. Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

The terminology used herein is for the purpose of describing embodiments of the present disclosure and is not intended to limit the present disclosure.

The type of secondary battery includes a coin type, a cylindrical type, a prismatic type, and a pouch type. Prior to a description of embodiments of the present disclosure, first, cylindrical and prismatic secondary batteries are roughly described because the present disclosure may be basically applied to the cylindrical and prismatic secondary batteries.

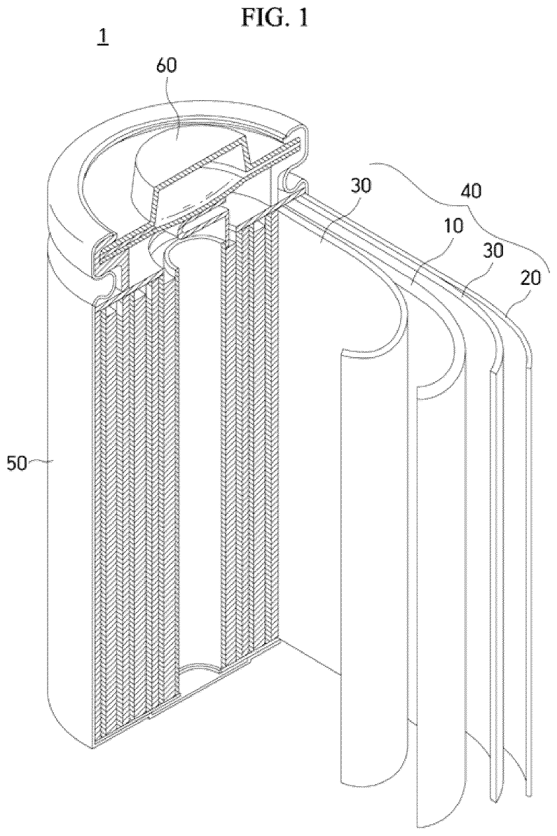

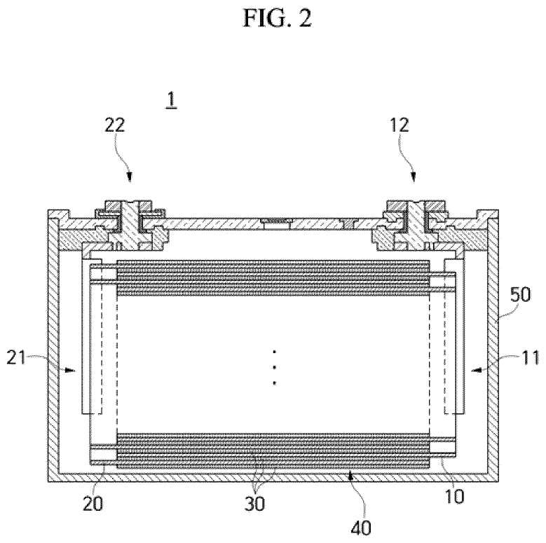

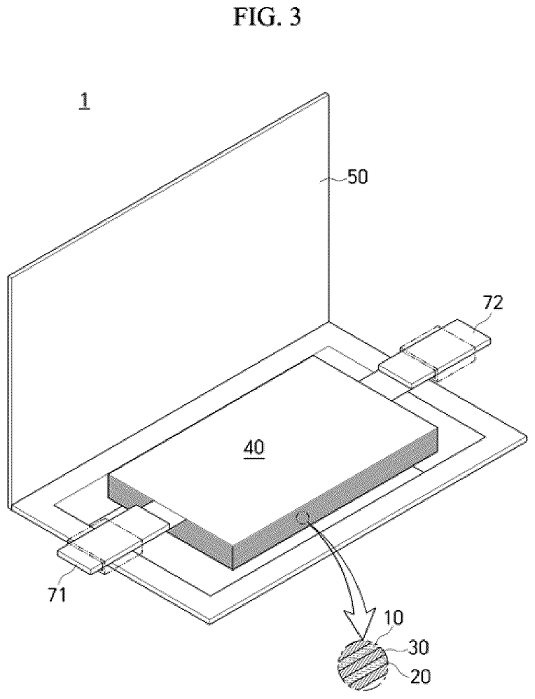

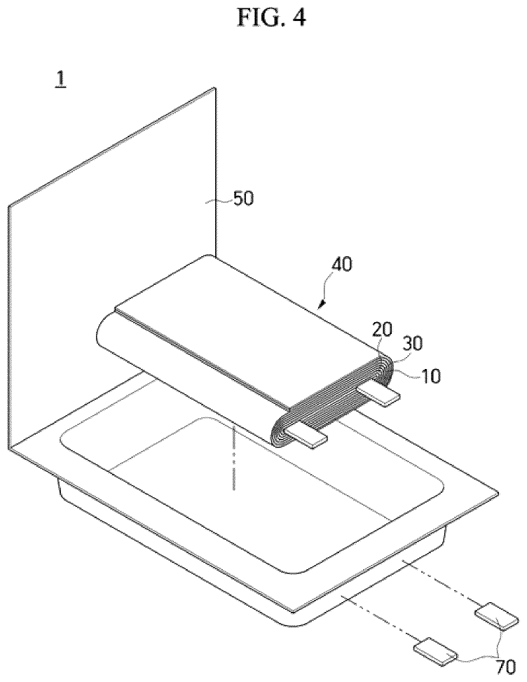

FIGS. 1 to 4 are schematic diagrams illustrating lithium secondary batteries according to implementation examples. FIG. 1 may illustrate a cylindrical lithium secondary battery. FIG. 2 may illustrate a prismatic type secondary battery. FIGS. 3 and 4 may illustrate a pouch type secondary battery. Referring to FIG. 1 to 4, a lithium secondary battery 1 may include, e.g., an electrode assembly 40 in which a separator 30 is between a first electrode plate 10 and a second electrode plate 20 and a case 50 in which the electrode assembly 40 has been embedded. The first electrode plate 10, the second electrode plate 20, and the separator 30 may be impregnated with an electrolyte. As illustrated in FIG. 1, the lithium secondary battery 1 may include a sealing member 60 that seals the case 50. Furthermore, in FIG. 2, the lithium secondary battery 1 may include, e.g., a first electrode lead tab 11, a first electrode terminal 12, a second electrode lead tab 21, and a second electrode terminal 22. As illustrated in FIGS. 3 and 4, the lithium secondary battery 1 may include, e.g., an electrode tab 70 that plays a role as an electrical passage for inducing a current formed in the electrode assembly 40 toward the outside, that is, a first electrode tab 71 and a second electrode tab 72.

The electrode assembly 40 may be, e.g., a winding type electrode assembly formed by winding or stacking a stack body including the first electrode plate 10, the second electrode plate 20, and the separator 30 each of which may be formed in a plate or film shape. In the case of the winding stack body, the winding axis of the electrode assembly 40 may be parallel to the length direction of the case. In an implementation, the electrode assembly 40 may be the stack type not the winding type. The first electrode plate 10 of the electrode assembly 40 may play a role as a positive electrode, and the second electrode plate 20 thereof may play a role as a negative electrode, and vice versa.

The first electrode plate 10 may be formed by applying a first electrode active material, e.g., graphite or carbon, to a first electrode collector plate formed of metal foil, e.g., copper, a copper alloy, nickel, or a nickel alloy, and may include a first electrode tab (or a first uncoated part), that is, an area to which the first electrode active material has not been applied. For example, the first electrode plate 10 may include a first electrode active material, e.g., graphite or carbon, on a first electrode collector plate including, e.g., copper alloy, nickel, or a nickel alloy. The first electrode plate 10 may include a first electrode tab.

The second electrode plate 20 may be formed by applying a second electrode active material, e.g., a transition metal oxide, to a material formed of metal foil, such as aluminum or an aluminum alloy, and may include a second electrode tab (or a second uncoated part), that is, an area to which the second electrode active material has not been applied. For example, the second electrode plate 20 may include a second electrode active material, e.g., a transition metal oxide, on a metal foil including, e.g., aluminum or an aluminum alloy. The first electrode plate 10 may include a first electrode tab.

The separator 30 may help prevent a short-circuit between the first electrode plate 10 and the second electrode plate 20 while permitting a movement of lithium ions. The separator 30 may include, e.g., a polyethylene film, a polypropylene film, or a polyethylene-polypropylene film.

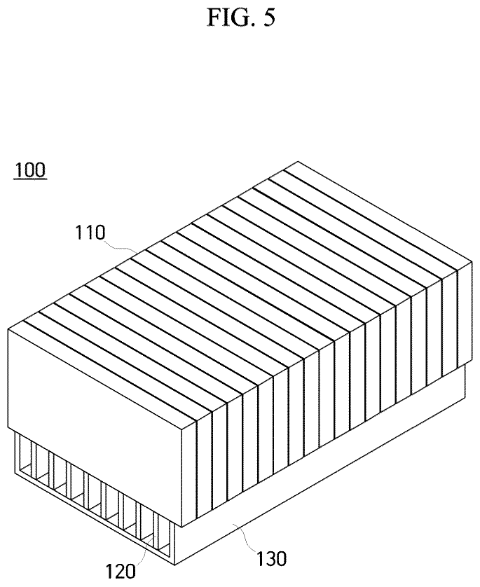

FIG. 5 is a diagram illustrating a cell and a cooling channel according to embodiments of the present disclosure.

Referring to FIG. 5, a battery according to embodiments of the present disclosure may include, e.g., a plurality of cells 110, a fin part 120, and a cooling channel 130.

The plurality of cells 110 may be included in e.g., a cylindrical secondary battery, an angular secondary battery, or a pouch-type secondary battery described above with reference to FIGS. 1 to 4.

The plurality of cells 110 may perform a charge function and a discharge function, the fin part 120 may include, e.g., a plurality of fins, and the cooling channel 130 may be under the plurality of cells 110 and may adjust a temperature of each of the cells 110.

Moreover, the fin part 120 may include the plurality of fins, and the cooling channel may include a fin having a multi-structure. For example, the plurality of fins may run parallel to one another and extend across the cooling channel in a lengthwise direction. Additionally, at least one of the plurality fins may have a multi-structure, e.g., have an inner portion formed of a different material than an outer portion.

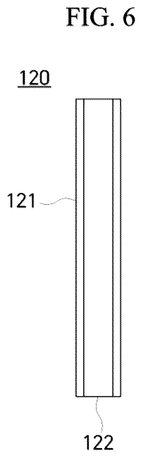

FIG. 6 is a cross-sectional view illustrating a cross-sectional surface of a fin 121 of the fin part 120 according to a first embodiment of the present disclosure.

Referring to FIG. 6, octadecane and silver nano particles may be inserted into the fin 121, and the fin 121 according to the first embodiment of the present disclosure may be formed by hardening the inserted octadecane and silver nano particles. For example, the fin 121 may have an outer portion and an inner portion. The outer portion of the fin 121 may be or include, e.g., a material used in conventional fins. The inner portion of the fin 121 may include a first layer 122 which may be or include hardened octadecane and silver nano particles.

Moreover, in another embodiment, octadecane and copper nano particles may be inserted into the fin part 120, and the fin part 120 may be formed by hardening the inserted octadecane and copper nano particles. For example, in another embodiment, the first layer 122 of the fin 121 may be or include hardened octadecane and copper nano particles.

To form a fin having a multi-structure instead of a structure of a conventional fin, a phase change material may be inserted into a fin, and in order to maintain a function of a conventional fin, a solid material having a composite structure into which silver nano particles or copper nano particles having a high temperature conductance are inserted may be mixed.

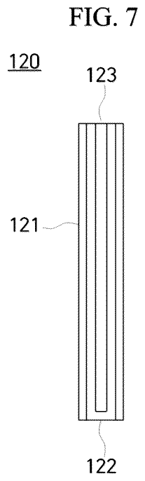

FIG. 7 is a cross-sectional view illustrating a cross-sectional surface of a fin 121 according to a second embodiment of the present disclosure.

Referring to FIG. 7, the fin part 120 according to the second embodiment of the present disclosure may have a multi-structure and may include a fin 121 having a first layer 122 including a first phase change material and a second layer 123 including a second phase change material.

Here, octadecane of a liquid state may be coated on an inner portion of the fin 121 and may be hardened, and thus, the first layer 122 may be 100 wt % octadecane, based on a total weight of the first layer 122.

Moreover, octadecane, silver nano particles, and multi-walled carbon nanotube (MWCNT) may be mixed and inserted into an internal empty space of the first layer, and hardened, and thus, the second layer 123 may be formed, and a temperature that octadecane, silver nano particles, and MWCNT may be mixed at may be about 40 degrees C. For example, the second layer may be at least partially surrounded by the first layer 122 and include a mixture of octadecane, silver nano particles, and multi-walled carbon nanotube (MWCNT).

Here, the solid material having a composite structure included in the second layer may include a combination of octadecane (82.8 wt %), silver nano particles [(5 μm to 10 μm in diameter)] (16.2 wt %), and MWCNT [(10 nm to 40 nm (diameter) and 10 μm to 50 μm (length)] (1.0 wt %).

Moreover, the second layer 123 may use copper nano particles instead of silver nano particles. Therefore, octadecane, copper nano particles, and MWCNT may be mixed, inserted into the internal empty space of the first layer, and hardened, and thus, the second layer 123 may be formed, and a temperature that octadecane, copper nano particles, and MWCNT may be mixed at may be about 40 degrees C.

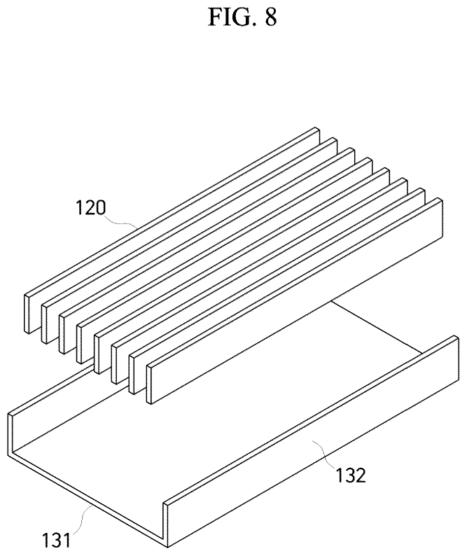

FIG. 8 is a diagram illustrating a cooling channel 130 according to embodiments of the present disclosure.

Referring to FIG. 8, the cooling channel 130 according to embodiments of the present disclosure may include, e.g., a fin part 120 including a plurality of fins 121, a lower plate part 131 which may be under the fin part 120 to fix, e.g., keep in place, the fin part 120, and a side bar 132 which may be connected to the lower plate part 131 to support both sides of the fin part 120.

Moreover, the fin part 120 may include at least one fin having a multi-structure.

The fin part 120 may include a plurality of fins 121, and the fin 121 may have a multi-structure. In an implementation, the fin 121 may include a first layer including a first phase change material and a second layer including a second phase change material.

Here, octadecane of a liquid state may be coated on an inner portion of the fin 121 and may be hardened, and thus, the first layer may be 100 wt % octadecane.

Moreover, octadecane, silver nano particles, and MWCNT may be mixed, may be inserted into an internal empty space of the first layer, and may be hardened, and thus, the second layer may be formed, and a temperature of when octadecane, silver nano particles, and MWCNT are mixed may be about 40 degrees C.

Here, the solid material having a composite structure included in the second layer may include a combination of octadecane (82.8 wt %), silver nano particles [(5 μm to 10 μm in diameter)] (16.2 wt %), and MWCNT [(10 nm to 40 nm (diameter) and 10 μm to 50 μm (length)] (1.0 wt %).

Moreover, the second layer 123 may use copper nano particles instead of silver nano particles. Therefore, octadecane, copper nano particles, and MWCNT may be mixed, inserted into the internal empty space of the first layer, and hardened, and thus, the second layer 123 may be formed, and a temperature that octadecane, copper nano particles, and MWCNT may be mixed at may be about 40 degrees C.

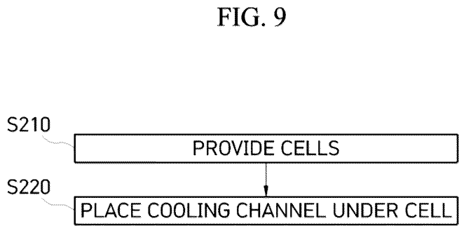

FIG. 9 is a flowchart for describing a method of manufacturing a battery according to embodiments of the present disclosure.

Referring to FIG. 9, the method of manufacturing a battery according to embodiments of the present disclosure may include, e.g., a step S210 of providing a plurality of cells performing a charge and discharge function and a step S220 of placing a cooling channel, adjusting a temperature of each of the cells, under the plurality of cells.

Here, the step S220 of placing the cooling channel may include, e.g., a step of manufacturing the cooling channel which may be configured in a multi-structure and may include a fin.

The step of manufacturing the cooling channel may include a step of manufacturing a fin including a layer which may be formed by inserting and hardening octadecane and silver nano particles in the fin and may use copper nano particles instead of silver nano particles. In an implementation, the step of manufacturing the cooling channel may include, e.g., a step of manufacturing a fin including a layer which may be formed by inserting and hardening octadecane and copper nano particles in the fin.

Moreover, the step of manufacturing the cooling channel may include, e.g., a step of forming a first layer, including a first phase change material, in the fin and a step of forming a second layer, including a second phase change material, in the fin.

The step of forming the first layer may include, e.g., a step of coating and hardening octadecane of a liquid state on an inner portion of the fin to form the first layer.

The step of forming the second layer may include, e.g., a step of mixing octadecane, silver nano particles, and MWCNT and inserting and hardening mixed materials into an internal empty space of the first layer to form the second layer.

In an implementation, the step of forming the second layer may include, e.g., a step of mixing octadecane, copper nano particles, and MWCNT and inserting and hardening mixed materials into the internal empty space of the first layer to form the second layer.

Hereinafter, materials which may be used in a secondary battery according to an embodiment of the present disclosure are described.

A compound (e.g., a lithiated intercalation compound) capable of reversible intercalation and deintercalation of lithium may be used as a positive electrode active material. In an implementation, complex oxides of a metal, e.g., cobalt, manganese, nickel, or a combination thereof, and lithium may be used as the positive electrode active material.

The complex oxide may be, e.g., a lithium transition metal complex oxide. In an implementation, the complex oxide may include, e.g., lithium nickel-based oxide, lithium cobalt-based oxide, lithium manganese-based oxide, a lithium ferrous phosphate-based compound, cobalt-free nickel-manganese-based oxide, or a combination thereof.

In an implementation, a compound that is, e.g., represented by one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O2 (0.90≤a≤1.8, 0.001≤b≤0.1); LiₐMn₂G_{b}O₄ (0.90≤a≤1.8, 0.001≤b≤0.1); LiₐMn_{1-g}G_{g}PO4 (0.90≤a≤1.8, 0≤g≤0.5); Li_{(3-f)}Fe₂(PO₄)₃ (0≤f≤2); and LiₐFePO₄ (0.90≤a≤1.8).

In the chemical formulae, A may be, e.g., Ni, Co, Mn, or a combination thereof. X may be, e.g., Al, Ni, Co, Mn, Cr, Fe, Mg, Sr, V, a rare earth element, or a combination thereof; D may be, e.g., O, F, S, P, or a combination thereof. G may be, e.g., Al, Cr, Mn, Fe, Mg, La, Ce, Sr, V, or a combination thereof. L¹ may be, e.g., Mn, Al, or a thereof.

A positive electrode for a lithium secondary battery may include, e.g., a current collector and a positive electrode active material layer on the current collector. The positive electrode active material layer may include, e.g., the positive electrode active material, and may further include a binder and/or a conductive material.

The content of the positive electrode active material may be, e.g., 90 wt % to 99.5 wt %, based on a total weight of the positive electrode active material layer. The content of the binder and the conductive material may be, e.g., 0.5 wt % to 5 wt %, based on a total weight of the positive electrode active material layer. In an implementation, Al may be used as the current collector.

A negative electrode active material may include a material capable of reversibly intercalation/de-intercalation with respect to lithium ions, lithium metal, an alloy of lithium metal, a material capable of doping and dedoping with respect to lithium, or transition metal oxide.

The material capable of reversibly intercalation/de-intercalation with respect to lithium ions may include a carbon-based negative electrode active material, e.g., crystalline carbon, amorphous carbon, or a combination of them. In an implementation, the crystalline carbon may include graphite, e.g., natural graphite or synthetic graphite. In an implementation, the amorphous carbon may include, e.g., soft or hard carbon, mesophase pitch carbide, or fired coke.

An Si-based negative electrode active material or an Sn-based negative electrode active material may be used as the material capable of doping and dedoping with respect to lithium. The Si-based negative electrode active material may be, e.g., silicon, a silicon-carbon composite, SiOₓ (0<x<2), a Si-based alloy, or a combination thereof.

The silicon-carbon composite may be, e.g., a composite of silicon and amorphous carbon. In an implementation, the silicon-carbon composite may include, e.g., silicon particles, and may have a form in which amorphous carbon has been coated on surfaces of silicon particles.

The silicon-carbon composite may further include crystalline carbon. In an implementation, the silicon-carbon composite may include, e.g., a core including crystalline carbon and silicon particles and an amorphous carbon coating layer on a surface of the core.

A negative electrode for a lithium secondary battery may include, e.g., a current collector and a negative electrode active material layer on the current collector. The negative electrode active material layer may include, e.g., the negative electrode active material, and may further include a binder and/or a conductive material.

In an implementation, the negative electrode active material layer may include, e.g., the negative electrode active material in an amount of 90 wt % to 99 wt %, the binder in an amount of 0.5 wt % to 5 wt %, and the conductive material in an amount of 0 wt % to 5 wt %, based on a total weight of the negative electrode active material layer.

A nonaqueous-based binder, an aqueous-based binder, a dry binder, or a combination of them may be used as the binder. If the aqueous-based binder is used as a binder for the negative electrode, the binder for the negative electrode may further include a cellulose-series compound capable of assigning viscosity.

In an implementation, nickel foil, stainless steel foil, titanium foil, nickel foam, copper foam, a polymer base on which a conductive metal has been coated, or a combination thereof may be used as a current collector for the negative electrode.

An electrolyte for a lithium secondary battery may include, e.g., a nonaqueous organic solvent and lithium salts.

The nonaqueous organic solvent may play a role as a medium through which ions that are involved in an electrochemical reaction of a battery can move.

The nonaqueous organic solvent may be, e.g., a carbonate, ester, ether, ketone, or alcohol solvent, an aprotic solvent, or a combination thereof. The carbonate, ester, ether, ketone, or alcohol solvent, or the aprotic solvent may be used solely, or two types or more of them may be mixed and used as the nonaqueous organic solvent.

In an implementation, if the carbonate-based solvent is used, annular carbonate and chain carbonate may be mixed and used.

A separator may be between the positive electrode and the negative electrode depending on the type of lithium secondary battery. Polyethylene, polypropylene, or polyvinylidene fluoride, or a multi-layer having two or more layers thereof may be used as the separator.

The separator may include, e.g., a porous base, and a coating layer including, e.g., an organic matter, an inorganic matter, or a combination of them that is on one or both sides of the porous base.

The organic matter may include, e.g., a polyvinylidene fluoride-based heavy antibody or (meth)acrylic polymer.

The inorganic matter may include inorganic particles, e.g., Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof.

The organic matter and the inorganic matter may have a form in which the organic matter and the inorganic matter have been mixed in one coating layer or a form in which a coating layer including the organic matter and a coating layer including the inorganic matter have been stacked

By way of summation and review, an aspect of the present disclosure may be directed to providing a battery using a multi fin structure, a method of manufacturing the battery, and a cooling channel, which may help delay thermal runaway in a battery using a multi fin structure.

Vehicular batteries have advanced to enlarge a surface area of a structure, so as to increase performance if bottom cooling technology is applied. However, if a fire occurs, a corresponding structure may not have a functionality for thermal delay.

According to embodiments of the present disclosure, by using the multi-walled carbon nanotube, the cost may be reduced in manufacturing of a battery.

Aspects and features of the present disclosure will be clearly understood by those skilled in the art from the description of the present disclosure above.

However, aspects and features of the present disclosure are not limited to those described above, and other aspects and features not mentioned will be clearly understood by a person skilled in the art from the detailed description, described above.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery using a multi fin structure, the battery comprising:
a plurality of cells configured to perform a charge and discharge function; and
a cooling channel under the plurality of cells to adjust a temperature of each of the plurality of cells, the cooling channel including a fin having a multi-structure.

2. The battery as claimed in claim 1, wherein the fin includes a layer in an inner portion including hardened octadecane and silver nano particles.

3. The battery as claimed in claim 1, wherein the fin includes a layer in an inner portion including hardened octadecane and copper nano particles.

4. The battery as claimed in claim 1, wherein the fin includes:
a first layer in an inner portion including a first phase change material, and
a second layer in an inner portion including a second phase change material.

5. The battery as claimed in claim 4, wherein the first layer includes hardened octadecane coated on an inner portion of the fin.

6. The battery as claimed in claim 5, wherein the second layer is in an internal space of the first layer and includes a hardened mixture of octadecane, silver nano particles, and multi-walled carbon nanotube (MWCNT).

7. The battery as claimed in claim 5, wherein the second layer is in an internal space of the first layer and includes a hardened mixture of octadecane, copper nano particles, and multi-walled carbon nanotube (MWCNT).

8. A method of manufacturing a battery using a multi fin structure, the method comprising:
a step of providing a plurality of cells configured to perform a charge and discharge function; and
a step of placing a cooling channel, configured to adjust a temperature of each of the cells, under the plurality of cells,
wherein the step of placing the cooling channel includes a step of manufacturing the cooling channel, the cooling channel including a fin having a multi-structure.

9. The method as claimed in claim 8, wherein the step of manufacturing the cooling channel includes a step of manufacturing a fin including a layer which is formed by inserting and hardening octadecane and silver nano particles into the fin.

10. The method as claimed in claim 8, wherein the step of manufacturing the cooling channel includes a step of manufacturing a fin including a layer which is formed by inserting and hardening octadecane and copper nano particles into the fin.

11. The method as claimed in claim 8, wherein the step of manufacturing the cooling channel includes:
a step of forming a first layer, including a first phase change material, in the fin; and
a step of forming a second layer, including a second phase change material, in the fin.

12. The method as claimed in claim 11, wherein the step of forming the first layer includes a step of coating and hardening octadecane of a liquid state on an inner portion of the fin to form the first layer.

13. The method as claimed in claim 12, wherein the step of forming the second layer includes a step of making a mixture including octadecane, silver nano particles, and multi-walled carbon nanotube (MWCNT) and inserting and hardening the mixture into an internal empty space of the first layer to form the second layer.

14. The method as claimed in claim 12, wherein the step of forming the second layer includes a step of making a mixture including octadecane, copper nano particles, and multi-walled carbon nanotube (MWCNT) and inserting and hardening the mixture into an internal empty space of the first layer to form the second layer.

15. A cooling channel using a multi fin structure, the cooling channel comprising:
a fin part including a plurality of fins;
a lower plate part under the fin part to fix the fin part; and
a side bar connected to the lower plate part to support both sides of the fin part,
wherein at least one fin of the plurality of fins has a multi-structure.

16. The cooling channel as claimed in claim 15, wherein the at least one fin includes a layer in an inner portion including hardened octadecane and silver nano particles.

17. The cooling channel as claimed in claim 15, wherein the at least one fin includes a layer in an inner portion including hardened octadecane and copper nano particles.

18. The cooling channel as claimed in claim 17, wherein the at least one fin includes:
a first layer in an inner portion including a first phase change material; and
a second layer in an inner portion including a second phase change material.

19. The cooling channel as claimed in claim 18, wherein the first layer includes hardened octadecane coated on an inner portion of the at least one fin.

20. The cooling channel as claimed in claim 19, wherein the second layer is in an internal space of the first layer and includes a hardened mixture of octadecane, silver nano particles, and multi-walled carbon nanotube (MWCNT).
